(19) United States
(12) Patent Application Publication
(10) Pub. No.: US 2023/0316677 A1
(43) Pub. Date: Oct. 5, 2023

(54) METHODS, DEVICES, APPARATUSES, AND STORAGE MEDIA FOR VIRTUALIZATION OF INPUT DEVICES

(71) Applicant: Beijing Source Technology Co., Ltd., Beijing (CN)

(72) Inventor: Zixiong Luo, Beijing (CN)

(73) Assignee: Beijing Source Technology Co., Ltd., Beijing (CN)

(21) Appl. No.: 18/176,253

(22) Filed: Feb. 28, 2023

(30) Foreign Application Priority Data
Feb. 28, 2022 (CN) 202210185778.9

(51) Int. Cl. G06T 19/00; G06F 3/01

(52) U.S. Cl. CPC G06T 19/006; G06F 3/017

(57) ABSTRACT

Disclosed herein are methods, apparatuses, devices, systems, and storage media for virtualizing an input device. In some embodiments, a method for virtualizing an input device includes: acquiring data of an input device, determining target information of a three-dimensional model corresponding to the input device in a virtual reality system based on the data of the input device, meanwhile acquiring three-dimensional data detected by an inertial sensor installed on the input device in real time, finally updating the target information of the three-dimensional model in the virtual reality system according to the three-dimensional data detected by the inertial sensor, and displaying the three-dimensional model at the updated target information in a virtual reality scene. According to the virtual method of the input device provided by the disclosure, the input device in real space can be accurately virtualized into the virtual reality scene, so that a subsequent user can conveniently and efficiently use the input device for interaction according to the three-dimensional model in the virtual reality scene.

### TECHNICAL FIELD

The present disclosure relates to the technical field of data, in particular to a method and apparatus of an input device, a device and a storage medium.

### BACKGROUND

At present, virtual scenes are widely used. To map a model corresponding to an entity input device into such a virtual scene, the model's shape and position must be determined. Typically, the shape and the position of the entity input device are mainly identified by image data collected by various cameras, such as color or infrared cameras, or through sensing data acquired by various detection sensors, such as radar waves. A persistent issue with the existing cameras and sensors is that when there is a barrier between the camera or detection sensor and the identified entity input device, the collected image or sensing data will be greatly incomplete, or even no image or data can be acquired, which will lead to inaccurate or even unrecognizable identification of the shape and the position of the entity input device, and further lead to the inability to display the model of the entity input device completely in the virtual scene.

### SUMMARY

To address the above-mentioned technical problems, the present disclosure provides methods, apparatuses, devices, systems, and storage media for virtualizing an input device, which can accurately map a three-dimensional model corresponding to the input device in a reality space into a virtual reality scene, thereby facilitating a user to subsequently perform an interaction operation according to a three-dimensional model in the virtual reality scene.

According to a first aspect of the present disclosure, a method for virtualizing an input device is provided. The method includes: acquiring data of the input device; determining target information of a three-dimensional model corresponding to the input device in a virtual reality system based on the data of the input device; acquiring three-dimensional data detected by an inertial sensor configured on the input device; updating the target information of the three-dimensional model in the virtual reality system according to the three-dimensional data acquired by the inertial sensor; and mapping the three-dimensional model into a virtual reality scene corresponding to the virtual reality system based on the updated target information.

According to a second aspect of the present disclosure, an apparatus for virtualizing an input device is provided. The apparatus includes: a first acquisition unit configured to acquire data of the input device; a determination unit configured to determine target information of a three-dimensional model corresponding to the input device in a virtual reality system based on the data of the input device; a second acquisition unit configured to acquire three-dimensional data of an inertial sensor; an updating unit configured to update the target information of the three-dimensional model in the virtual reality system according to the three-dimensional data of the inertial sensor; and a mapping unit configured to map the three-dimensional model into a virtual reality scene corresponding to the virtual reality system based on the updated target information.

According to a third aspect of the present disclosure, a system is provided. The system includes: a memory; a processor; and a computer program. The computer program is stored in the memory. The computer program, when being executed by the processor, causes the processor to: acquire data of the input device; determine target information of a three-dimensional model corresponding to the input device in a virtual reality system based on the data of the input device; acquire three-dimensional data of an inertial sensor; update the target information of the three-dimensional model in the virtual reality system according to the three-dimensional data of the inertial sensor; and map the three-dimensional model into a virtual reality scene corresponding to the virtual reality system based on the updated target information.

According to a fourth aspect of the present disclosure, a computer readable storage medium is provided. The computer readable storage medium stores a computer program thereon, wherein the computer program, when being executed by a processor, implements the steps of the method for virtualizing the input device as mentioned above.

According to a fifth aspect of the present disclosure provides a computer program product includes a computer program or instruction, wherein the computer program or instruction, when executed by a processor, implements the method for virtualizing the input device as mentioned above.

According to the method for virtualizing the input device in accordance with some embodiments of the present disclosure, the data of the input device is acquired, then the target information of the three-dimensional model corresponding to the input device in the virtual reality system is determined based on the data of the input device, and meanwhile, the three-dimensional data detected by the inertial sensor installed on the input device is acquired in real time, then the target information of the three-dimensional model in the virtual reality system is updated according to the three-dimensional data detected by the inertial sensor, and the three-dimensional model is displayed at the updated target information in the virtual reality scene. The method for virtualizing the input device in accordance with some embodiments of the present disclosure can accurately map the input device in the reality space into the virtual reality scene, thereby facilitating the user to subsequently perform the interaction operation according to the three-dimensional model in the virtual reality scene.

### BRIEF DESCRIPTION OF THE DRAWINGS

The accompanying drawings herein are incorporated into the specification and constitute a part of the specification, show the embodiments consistent with the present disclosure, and serve to explain the principles of the present disclosure together with the specification.

In order to illustrate the technical solutions in the embodiments of the present disclosure or the prior art more clearly, the accompanying drawings to be used in the description of the embodiments or the prior art will be briefly described below. Obviously, those of ordinary skills in the art can also obtain other drawings based on these drawings without going through any creative work.

FIG. 1 is a schematic diagram of an application scene in accordance with some embodiments of the present disclosure;

FIG. 2 is a schematic flow chart of a method for virtualizing an input device provided by the embodiments of the present invention;

FIG. 3a is a schematic diagram of another application scene in accordance with some embodiments of the present disclosure;

FIG. 3b is a schematic diagram of a virtual reality scene in accordance with some embodiments of the present disclosure;

FIG. 3c a schematic diagram of another application scene in accordance with some embodiments of the present disclosure;

FIG. 4 is a schematic flow chart of a method for virtualizing an input device in accordance with some embodiments of the present disclosure;

FIG. 5 is a schematic structural diagram of an apparatus for virtualizing an input device in accordance with some embodiments of the present disclosure; and

FIG. 6 is a schematic structural diagram of an electronic device and system for virtualizing an input device in accordance with some embodiments of the present disclosure.

### DETAILED DESCRIPTION

In order to better understand the above objects, features and advantages of the present disclosure, the solutions of the present disclosure will be further described below. It should be noted that, in case of no conflict, the embodiments in the present disclosure and the features in the embodiments may be mutually combined with each other.

In the following description, many specific details are set forth in order to fully understand the present disclosure, but the present disclosure may be implemented in other ways different from those described herein. Obviously, the embodiments described in the specification are merely a part of, rather than all of, the embodiments of the present disclosure.

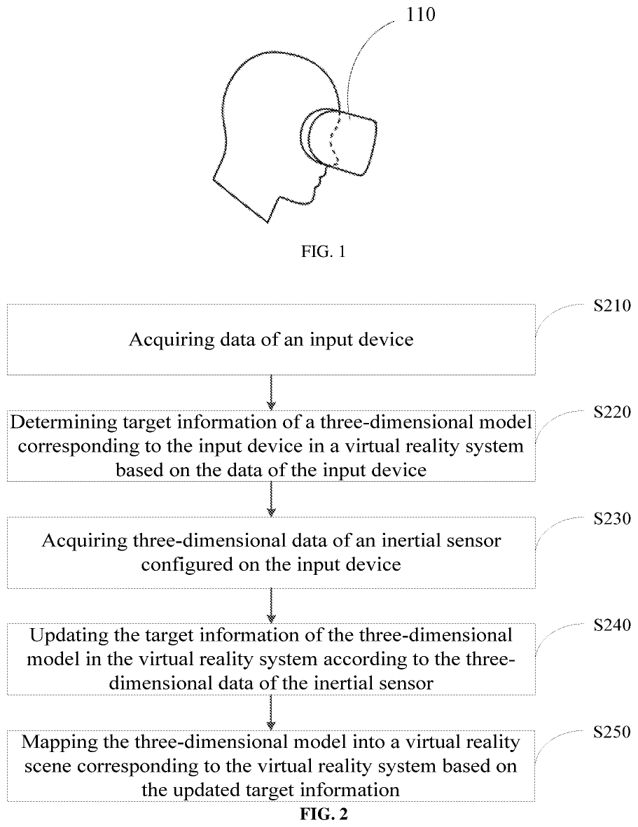

At present, in a virtual reality system, interactions between a user and a virtual scene may typically be achieved through an input device. The virtual reality system may include a head-mounted display and a virtual reality software system. The virtual reality software system may specifically include an operating system, a software algorithm for image recognition, a software algorithm for spatial calculation and rendering software for rendering virtual scenes. For example, referring to FIG. 1, a schematic diagram of an application scene in accordance with some embodiments of the present disclosure is illustrated. FIG. 1 includes a head-mounted display 110. The head-mounted display 110 may be an all-in-one machine. The all-in-one machine means that the head-mounted display 110 is configured with a virtual reality software system. The head-mounted display 110 may also be connected to a server, and the server is configured with a virtual reality software system. Specifically, the following embodiment takes a virtual reality software system configured on a head-mounted display as an example to explain in detail the method for virtualizing the input device provided by the present disclosure. The head-mounted display device is connected to the input device, and the input device may be, for example, a mouse, a keyboard, etc.

In view of the above technical problems, the embodiments of the present disclosure provide a method for virtualizing input device. According to the present disclosure, attitude information and position information of a physical input device are calculated by acquiring three-dimensional data including magnetic force, gyroscope and acceleration of an inertial sensor fixed inside or outside the physical input device, so that a three-dimensional model corresponding to the physical input device is displayed in a virtual scene, and a user can use the physical input device through the three-dimensional model to perform input operations efficiently. The method for virtualizing the input device provided by the present disclosure is not affected by occlusion, and can effectively solve the problem that a camera or a detection sensor is occluded while shooting images in the existing method, and the entity input device can work normally even if the entity input device is completely occluded. Specifically, the method for virtualizing the input device is described in detail hereinafter with reference to one or more specific embodiments.

FIG. 2 is a flow chart illustrating a method for virtualizing an input device in accordance with some embodiments of the present disclosure, which may be applied to a virtual reality system. The method may specifically include the following steps S210 to S240 as shown in FIG. 2.

It is to be noted that the virtual reality software system may be implemented in a head-mounted display, and the virtual reality software system can process a received input signal or data transmitted by the input device, and return a processing result to a display screen in the head-mounted display, and then the display screen changes a display state of the input device in the virtual reality scene in real time according to the processing result.

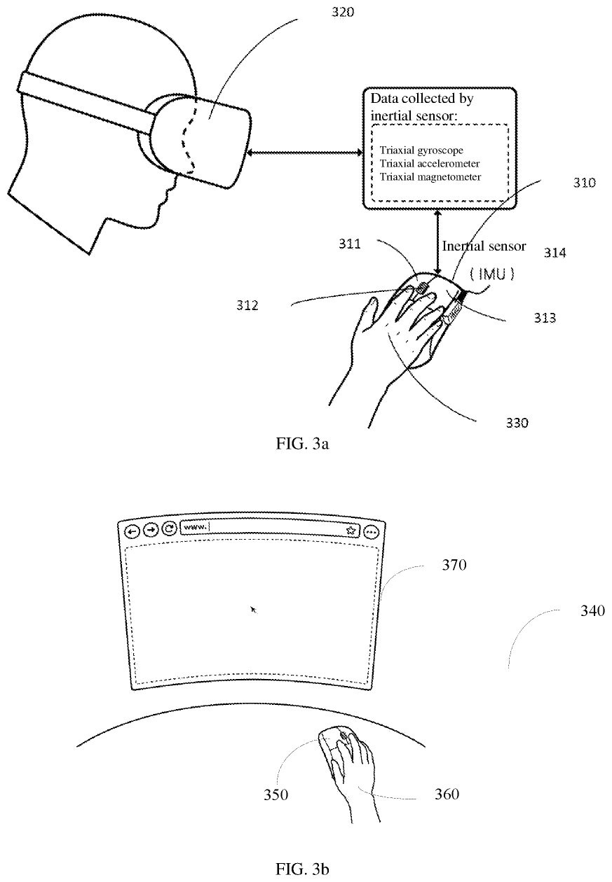

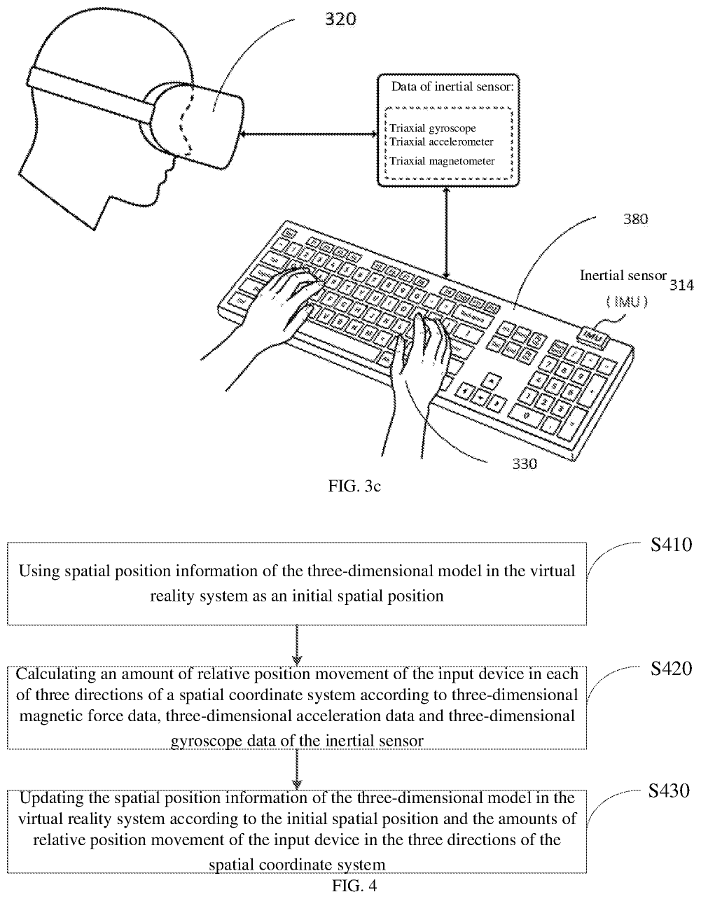

For example, referring to FIG. 3a, a schematic diagram of another application scene in accordance with some embodiments of the present disclosure is illustrated. FIG. 3a includes a mouse 310, a head-mounted display 320, and a user hand 330. The mouse 310 includes a left key 311, a roller wheel 312, a right key 313, and an inertial sensor 314. The inertial sensor 314 is shown as a black box on the mouse 310 in FIG. 3a. The inertial sensor 314 may be configured on a surface of the mouse 310. The user wears the head-mounted display 320, and the hand 330 operates the mouse 310. Meanwhile, the mouse 310 is connected to the head-mounted display 320. 340 in FIG. 3b is a scene built in the head-mounted display 320 in FIG. 3a, which may be referred to as a virtual reality scene 340. The user can understand and manipulate the mouse 310 by watching a mouse model 350 corresponding to the mouse 310 displayed in the virtual reality scene 340, so that the user can see that a three-dimensional model 360 corresponding to the user hand 330 operates the mouse model 350 corresponding to the mouse 310 in the virtual reality scene 340. An operation interface 370 is an interface for mouse operation, which is similar to a display screen of a terminal. In the virtual reality scene 340, the operation of the hand model 360 operating the mouse model 350 and the actual operation of the user hand 330 using the mouse 310 can be synchronized to a certain extent, which is equivalent to two eyes of the user directly seeing elements in the mouse and carrying out subsequent operations, thus improving the user experience and increasing an interaction speed. It is to be noted that the method for virtualizing the input device provided by the following embodiment will be explained by taking the application scene shown in FIG. 3a as an example. That is, the method for virtualizing the input device provided by the present disclosure will be explained in detail by taking a mouse as an example of the input device and taking a mouse model as an example of the three-dimensional model. For example, referring to FIG. 3c, a schematic diagram of another application scene in accordance with some embodiments of the present disclosure is shown. FIG. 3c includes a keyboard 380, a head-mounted display 320, and a user hand 330. An application scene of the keyboard 380 is the same as that of the mouse 310 in FIG. 3a and will not be repeated here.

At S210, data of the input device may be acquired.

Understandably, a virtual reality software system acquires the data of the input device in real time, wherein the data of the input device may include configuration information, an input signal and an image of the input device, and the like, wherein the configuration information includes model information, and the model information refers to a model of the input device.

Optionally, before determining target information of a three-dimensional model corresponding to the input device in a virtual reality system based on the data of the input device, model information of the input device may be acquired; and a three-dimensional model corresponding to the input device is determined according to the model information.

Understandably, after the three-dimensional model corresponding to the input device is confirmed for the first time, a user only needs to obtain the input signal and the image of the input device in order to quickly and accurately update a display state of the three-dimensional model in the virtual reality scene when not changing the input device.

At S220, the target information of the three-dimensional model corresponding to the input device in the virtual reality system is determined based on the data of the input device.

Understandably, based on S210, after determining a mouse model corresponding to the mouse according to the configuration information of the mouse, the virtual reality software system can determine target information of the mouse model in the virtual reality system based on the input signal of the mouse or the image of the mouse, wherein the target information includes position information and attitude information.

For example, the head-mounted display 320 shown in FIG. 3a may be equipped with a plurality of cameras, specifically equipped with three to four cameras, to capture environmental information around a user head in real time and determine a positional relationship between the captured environmental information and the head-mounted display and construct a space. The space may be referred to as a target space, in which the mouse and the user hand are located. Understandably, the scene displayed in the virtual reality scene may be the scene in the target space. The target information is the position information and the attitude information in the target space.

Optionally, at the above mentioned S220, determining the target information of the three-dimensional model corresponding to the input device in the virtual reality system based on the data of the input device, specifically including determining the target information of the three-dimensional model corresponding to the input device in the virtual reality system based on the input signal of the input device.

The virtual reality software system may determine the target information of the mouse model in the virtual reality system according to the acquired input signal of the mouse, wherein the input signal may be generated by pressing the key or the roller wheel on the mouse, so as to display the mouse model at the target information in the virtual reality scene. In this case, the attitude of the mouse model displayed in the virtual reality scene is the same as that of the mouse in a real space.

Optionally, at the above mentioned S220, the determining the target information of the three-dimensional model corresponding to the input device in the virtual reality system based on the data of the input device, may further include determining the target information of the three-dimensional model corresponding to the input device in the virtual reality system based on the image of the input device.

In some embodiments, the virtual reality software system may also determine the target information of the mouse model in the virtual reality system according to the acquired image of the mouse, so as to display the mouse model at the target information in the virtual reality scene. In this case, the attitude of the mouse model displayed in the virtual reality scene is the same as that of the mouse in a real space. The image of the mouse may be shot and generated in real time by a camera installed on the head-mounted display 320, wherein the camera may be an infrared camera, a color camera, or a grayscale camera. Specifically, an image including the mouse 310 may be captured by the camera installed on the head-mounted display 320 in FIG. 3a, and the image may be transmitted to the virtual reality software system in the head-mounted display for processing.

Understandably, the target information of the mouse model corresponding to the mouse in the virtual reality system may be determined by the above two ways of identifying the input signal of the mouse and/or the keys in the image of the mouse device, and the target information of the mouse model in the virtual reality system can be determined by selecting either or both of the above two ways, which can effectively avoid the occurrence that the complete image of the mouse cannot be shot or the input signal of the mouse cannot be normally received, and the interactive operation can be continued, thus improving usability. The target information of the mouse model in the virtual reality system determined by the above two ways may be regarded as the initial target information corresponding to the mouse described below, and the initial target information may also be called the initial position.

Optionally, after the target information of the three-dimensional model in the virtual reality system is determined, the three-dimensional model is mapped into a virtual reality scene constructed by the virtual reality system.

Understandably, after the target information of the mouse model in the virtual reality system is determined, the mouse model may be displayed in the virtual reality scene at the target information, that is, at the determined initial target information.

At S230, three-dimensional data of the inertial sensor configured on the input device are acquired.

Understandably, the mouse is pre-configured with an inertial sensor, which may collect three-dimensional data about the mouse in real time. The inertial sensor, also referred to as an Inertial Measurement Unit (IMU), is an apparatus that may measure a triaxial attitude angle and an acceleration of an object.

The data collected by the inertial sensor may include three groups of data, such as triaxial gyroscope, triaxial accelerometer, and triaxial magnetometer. Each group of data includes data in three directions of X, Y and Z, that is, nine data items. The triaxial gyroscope is used to measure a triaxial angular velocity of the mouse. The triaxial accelerometer is used to measure a triaxial acceleration of the mouse. The triaxial magnetometer is used to provide a triaxial orientation of the mouse. Positioning information may include the nine data items described above. The target information of the mouse model in the virtual reality system can be accurately determined according to the positioning information and the initial target information.

Optionally, the inertial sensor configured on the input device at least includes one of the following situations. In one implementation, the inertial sensor is positioned on a surface of the input device. In another implementation, the inertial sensor is positioned inside the input device.

Understandably, the inertial sensor may be configured on a surface of the mouse. For example, as shown in FIG. 3a, the inertial sensor is configured on a surface of an ordinary mouse, such as an upper right corner. In this case, the inertial sensor may be regarded as an independent device not controlled by the mouse, provided with a power module, and the like, and may be directly installed on the mouse device. The inertial sensor may also be configured inside the mouse device, for example, in an internal circuit of the mouse. In this case, it may be understood that the mouse is provided with an inertial sensor.

At S240, the target information of the three-dimensional model in the virtual reality system is updated according to the three-dimensional data of the inertial sensor.

Understandably, based on S230 and S220, the target information of the mouse model in the virtual reality system is re-determined according to the three-dimensional data of the inertial sensor obtained in real time, and the mouse model is displayed at the re-determined target information in the virtual reality scene. After determining the initial target information of the mouse model in the virtual reality system, the mouse in the real space may move. In this case, the target information of the mouse model in the virtual reality system can be re-determined according to the positioning information about the mouse device obtained by the inertial sensor in real time, wherein the target information is determined relative to the initial target information.

At S250, the three-dimensional model is mapped into a virtual reality scene corresponding to the virtual reality system based on the updated target information.

Understandably, based on the above S240, after the target information of the mouse model in the target space is updated, the mouse model is displayed in the virtual reality scene at the re-determined target information, wherein the virtual reality scene shows the scene in the target space.

According to the method for virtualizing the input device in accordance with some embodiments of the present disclosure, the data of the input device is acquired, then the target information of the three-dimensional model corresponding to the input device in the virtual reality system is determined based on the data of the input device. Meanwhile, the three-dimensional data detected by the inertial sensor installed on the input device is acquired in real time. The target information of the three-dimensional model in the virtual reality system is then updated according to the three-dimensional data detected by the inertial sensor, and the three-dimensional model is displayed at the updated target information in the virtual reality scene. The method for virtualizing the input device in accordance with some embodiments of the present disclosure can accurately map the input device in the reality space into the virtual reality scene, thereby facilitating the user to subsequently perform the interaction operation according to the three-dimensional model in the virtual reality scene.

According to the above embodiment, FIG. 4 is a schematic flow chart of a method for virtualizing the input device in accordance with some embodiments of the present disclosure. Optionally, the target information includes spatial position information, wherein the spatial position information refers to position information of the input device in a target space. Afterwards, the target information of the three-dimensional model in the virtual reality system is updated according to the three-dimensional data of the inertial sensor. That is, the spatial position information of the three-dimensional model in the target space is updated, which specifically includes the steps S410 to S430 as shown in FIG. 4.

At S410, spatial position information of the three-dimensional model in the virtual reality system is used as an initial spatial position.

In some embodiments, the inertial sensor may acquire movement trajectory and attitude of the input device relative to an initial position from a certain moment in real time. That is, the data collected by the inertial sensor needs to give the initial position to clarify the specific starting point or standard of the movement trajectory and attitude collected later. For example, if the initial position is not given, the inertial sensor may also collect the data of the mouse in real time, but the collected data may only include the movement trajectory and attitude information such as right translation, but it is impossible to accurately determine where the mouse is translated to the right and a specific position after translation, so it is necessary to determine the initial spatial position to accurately determine the specific position of the mouse after moving. The initial spatial position is within the above-mentioned constructed target space, and the specific position is also in the same target space.

At S420, an amount of relative position movement of the input device in each of three directions of a spatial coordinate system may be calculated according to three-dimensional magnetic force data, three-dimensional acceleration data, and three-dimensional gyroscope data collected by the inertial sensor.

In some embodiments, according to the three-dimensional data about the mouse collected by the inertial sensor, including three-dimensional magnetic force data, three-dimensional acceleration data, and three-dimensional gyroscope data, the amounts of relative position movement of the input device in three directions in the spatial coordinate system of the target space are calculated, wherein the relative amounts of position movement are moving distances of the input device in the three directions of X, Y and Z in the target space. The data collected by the inertial sensor may also be regarded as a distance variation based on the initial spatial position.

At S430, the spatial position information of the three-dimensional model in the virtual reality system is updated according to the initial spatial position and the amounts of relative position movement of the input device in the three directions of the spatial coordinate system.

In some embodiments, according to S410 and S420, the target information of the mouse model in the virtual reality system may be updated according to the initial spatial position and the amounts of relative position movement of the mouse in the three directions of the spatial coordinate system. For example, spatial three-dimensional coordinates in the initial position are (1, 2, 3), and the inertial sensor measures that the mouse moves by one unit along the X axis. When the attitude of the mouse is not changed, the three-dimensional coordinates of the mouse model are updated to (2, 2, 3), and the three-dimensional coordinates (position information) and unchanged attitude information in this case are the target information of the updated mouse model in the virtual reality system.

Optionally, the method further includes updating the initial spatial position; and correcting a calculation error according to the updated initial spatial position.

In some embodiments, when calculating the updated target information of the mouse model based on the data obtained by the inertial sensor and the initial spatial position, calculation errors may be accumulated. The calculation error can be corrected by re-determining the initial spatial position. The initial spatial position may be updated as described above. The initial spatial position can be obtained by an image recognition method and/or key pressing method, which will not be repeated here. For example, after an initial spatial position A is determined, the target information of the mouse in the virtual reality system is determined five times later. After more than five times, an initial spatial position B can be re-determined, and an error caused by the calculation based on the initial spatial position A can be corrected based on the initial spatial position B, that is, the calculation error can be corrected periodically according to the initial spatial position.

Optionally, the target information further includes attitude information; and the updating the target information of the three-dimensional model in the virtual reality system according to the three-dimensional data of the inertial sensor, includes: updating the attitude information of the three-dimensional model in the virtual reality system according to three-dimensional magnetic force data, three-dimensional acceleration data and three-dimensional gyroscope data of the inertial sensor and a spatial position of the inertial sensor relative to the input device.

Understandably, the target information further includes attitude information, and the method of determining the attitude information of the input device in the target space specifically includes: updating the attitude information of the three-dimensional model in the virtual reality system according to three-dimensional magnetic force data, three-dimensional acceleration data and three-dimensional gyroscope data of the inertial sensor and a spatial position of the inertial sensor relative to the input device. The spatial position of the inertial sensor relative to the input device refers to a specific position of the sensor on the input device. For example, in FIG. 3a, the inertial sensor 314 is configured on the upper right of the surface of the mouse 310, that is, the corresponding relationship between the inertial sensor on the input device and the target space is established, so as to calculate the attitude information of the three-dimensional model corresponding to the input device in the target space. Understandably, in the process of calculating the attitude information of the three-dimensional model, the initial spatial position of the input device is not needed.

According to the method for virtualizing the input device in accordance with some embodiments of the present disclosure, after the initial spatial position of the three-dimensional model in the virtual reality scene is determined, the target information of the three-dimensional model in the virtual reality system is re-determined based on the initial spatial position, so as to update the display state of the three-dimensional model in the virtual reality scene in real time, quickly and accurately according to the display state of the input device in the real space, and facilitate subsequent operations.

FIG. 5 is a schematic structural diagram of a virtual apparatus of an input device in accordance with some embodiments of the present disclosure. The virtual apparatus of the input device in accordance with some embodiments of the present disclosure can execute the processing flow provided by the above embodiments of the method for virtualizing the input device. As shown in FIG. 5, apparatus 500 includes:
a first acquisition unit 510 configured to acquire data of the input device;
a determination unit 520 configured to determine target information of a three-dimensional model corresponding to the input device in a virtual reality system based on the data of the input device;
a second acquisition unit 530 configured to acquire three-dimensional data of an inertial sensor;
an updating unit 540 configured to update the target information of the three-dimensional model in the virtual reality system according to the three-dimensional data of the inertial sensor; and
a mapping unit 550 configured to map the three-dimensional model into a virtual reality scene corresponding to the virtual reality system based on the updated target information.

Optionally, the target information in the apparatus 500 includes attitude information.

Optionally, the updating the target information of the three-dimensional model in the virtual reality system by the updating unit 540 according to the three-dimensional data of the inertial sensor, is specifically configured for:

updating the attitude information of the three-dimensional model in the virtual reality system according to three-dimensional magnetic force data, three-dimensional acceleration data and three-dimensional gyroscope data of the inertial sensor and a spatial position of the inertial sensor relative to the input device.

Optionally, the target information in the apparatus 500 further includes spatial position information.

Optionally, the updating the target information of the three-dimensional model in the virtual reality system by the updating unit 540 according to the three-dimensional data of the inertial sensor, is specifically configured for:
using spatial position information of the three-dimensional model in the virtual reality system as an initial spatial position;
calculating relative amounts of position movement of the input device in three directions of a spatial coordinate system according to three-dimensional magnetic force data, three-dimensional acceleration data and three-dimensional gyroscope data of the inertial sensor; and
updating the spatial position information of the three-dimensional model in the virtual reality system according to the initial spatial position and the relative amounts of position movement of the input device in the three directions of the spatial coordinate system.

Optionally, the inertial sensor configured on the input device in the apparatus 500 at least includes one of the following situations:
the inertial sensor is configured on a surface of the input device; and
the inertial sensor is configured inside the input device.

Optionally, the apparatus 500 further includes a correction unit, configured to update the initial spatial position; and correcting a calculation error according to the updated initial spatial position.

The virtual apparatus of the input device in the embodiment shown in FIG. 5 may be used to implement the technical solution of the above-mentioned method embodiments, and the implementation principle and technical effects thereof are similar, which will not be described here.

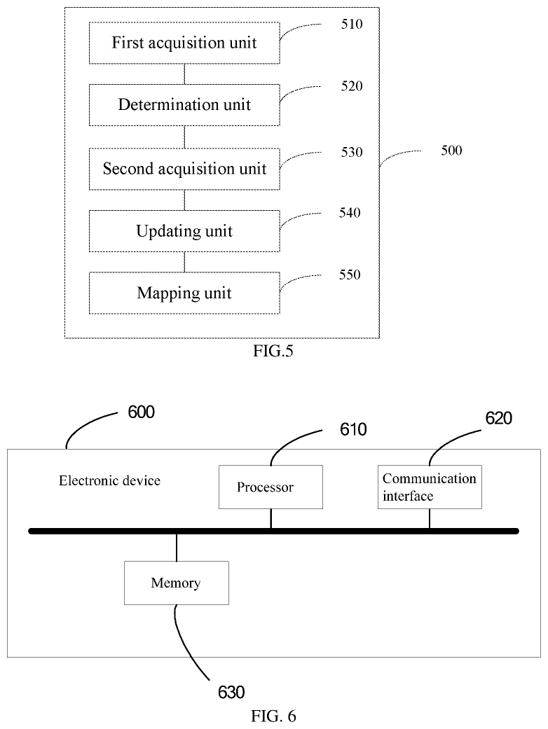

FIG. 6 is a schematic structural diagram of an electronic device in accordance with some embodiments of the present disclosure. The electronic device in accordance with some embodiments of the present disclosure can execute the processing flow provided by the above embodiments. As shown in FIG. 6, the electronic device 600 includes a processor 610, a communication interface 620 and a memory 630; wherein the computer program is stored in the memory 630 and is configured to be executed by the processor 610 to execute the method for virtualizing the input device as mentioned above.

Moreover, the embodiments of the present disclosure further provide a computer readable storage medium storing a computer program thereon, wherein the program is executed by a processor to implement the method for virtualizing the input device as mentioned above.

Moreover, the embodiments of the present disclosure also provides a computer program product including a computer program or instruction, wherein the computer program or instruction, when executed by a processor, implements the method for virtualizing the input device as mentioned above.

It should be noted that relational terms herein such as “first”, “second”, and the like, are used merely to distinguish one entity or operation from another entity or operation, and do not necessarily require or imply there is any such relationship or order between these entities or operations. Furthermore, the terms “including”, “comprising” or any variations thereof are intended to embrace a non-exclusive inclusion, such that a process, method, article, or device including a plurality of elements includes not only those elements but also includes other elements not expressly listed, or also incudes elements inherent to such a process, method, article, or device. In the absence of further limitation, an element defined by the phrase “including a . . . ” does not exclude the presence of additional identical element in the process, method, article, or device.

The above are only specific embodiments of the present disclosure, so that those skilled in the art can understand or realize the present disclosure. Various modifications to these embodiments will be apparent to those skilled in the art, and the generic principles defined herein may be embodied in other embodiments without departing from the spirit or scope of the present disclosure. Therefore, the present disclosure will not to be limited to these embodiments shown herein but is to be in conformity with the widest scope consistent with the principles and novel features disclosed herein.

1. A method for virtualizing an input device, comprising:
acquiring data of the input device;
determining target information of a three-dimensional model corresponding to the input device in a virtual reality system based on the data of the input device;
acquiring three-dimensional data detected by an inertial sensor configured on the input device;
updating the target information of the three-dimensional model in the virtual reality system according to the three-dimensional data acquired by the inertial sensor; and
mapping the three-dimensional model into a virtual reality scene corresponding to the virtual reality system based on the updated target information.

2. The method according to claim 1, wherein the target information comprises attitude information, and wherein updating the target information of the three-dimensional model in the virtual reality system according to the three-dimensional data detected by the inertial sensor comprises:
updating the attitude information of the three-dimensional model in the virtual reality system according to three-dimensional magnetic force data, three-dimensional acceleration data, and three-dimensional gyroscope data collected by the inertial sensor and a spatial position of the inertial sensor relative to the input device.

3. The method according to claim 1, wherein the target information comprises spatial position information, and wherein updating the target information of the three-dimensional model in the virtual reality system according to the three-dimensional data detected by the inertial sensor comprises:
using spatial position information of the three-dimensional model in the virtual reality system as an initial spatial position;
calculating an amount of relative position movement of the input device in each of three directions of a spatial coordinate system according to three-dimensional magnetic force data, three-dimensional acceleration data, and three-dimensional gyroscope data collected by the inertial sensor; and
updating the spatial position information of the three-dimensional model in the virtual reality system according to the initial spatial position and the amount of relative position movement of the input device in each of the three directions of the spatial coordinate system.

4. The method according to claim 3, wherein the method further comprises:
updating the initial spatial position; and
correcting a calculation error according to the updated initial spatial position.

5. The method according to claim 1, wherein the inertial sensor is positioned on a surface of the input device or inside the input device.

6-10. (canceled)

11. An apparatus for virtualizing an input device, comprising:
a first acquisition unit configured to acquire data of the input device;
a determination unit configured to determine target information of a three-dimensional model corresponding to the input device in a virtual reality system based on the data of the input device;
a second acquisition unit configured to acquire three-dimensional data of an inertial sensor;
an updating unit configured to update the target information of the three-dimensional model in the virtual reality system according to the three-dimensional data of the inertial sensor; and
a mapping unit configured to map the three-dimensional model into a virtual reality scene corresponding to the virtual reality system based on the updated target information.

12. The apparatus according to claim 11, wherein the target information comprises attitude information, and wherein the updating unit is further configured to:
update the attitude information of the three-dimensional model in the virtual reality system according to three-dimensional magnetic force data, three-dimensional acceleration data and three-dimensional gyroscope data collected by the inertial sensor and a spatial position of the inertial sensor relative to the input device.

13. The apparatus according to claim 11, wherein the target information comprises spatial position information, and wherein the updating unit is further configured to:
use spatial position information of the three-dimensional model in the virtual reality system as an initial spatial position;
calculate an amount of relative position movement of the input device in three directions of a spatial coordinate system according to three-dimensional magnetic force data, three-dimensional acceleration data, and three-dimensional gyroscope data collected by the inertial sensor; and
update the spatial position information of the three-dimensional model in the virtual reality system according to the initial spatial position and the amount of relative position movement of the input device in the three directions of the spatial coordinate system.

14. The apparatus according to claim 13, wherein the inertial sensor is positioned on a surface of the input device.

15. The apparatus according to claim 13, wherein the inertial sensor is positioned inside the input device.

16. An electronic device, comprising:
a memory; and
a processor, wherein the processor is to:
acquire data of an input device;
determine target information of a three-dimensional model corresponding to the input device in a virtual reality system based on the data of the input device;
acquire three-dimensional data detected by an inertial sensor configured on the input device;
update the target information of the three-dimensional model in the virtual reality system according to the three-dimensional data acquired by the inertial sensor; and
map the three-dimensional model into a virtual reality scene corresponding to the virtual reality system based on the updated target information.

17. The electronic device according to claim 16, wherein the target information comprises attitude information, and wherein the processor is further configured to:
update the attitude information of the three-dimensional model in the virtual reality system according to three-dimensional magnetic force data, three-dimensional acceleration data and three-dimensional gyroscope data collected by the inertial sensor and a spatial position of the inertial sensor relative to the input device.

18. The electronic device according to claim 16, wherein the target information comprises spatial position information, and wherein the processor is further to:
use spatial position information of the three-dimensional model in the virtual reality system as an initial spatial position;
calculate an amount of relative position movement of the input device in three directions of a spatial coordinate system according to three-dimensional magnetic force data, three-dimensional acceleration data, and three-dimensional gyroscope data collected by the inertial sensor; and
update the spatial position information of the three-dimensional model in the virtual reality system according to the initial spatial position and the amount of relative position movement of the input device in the three directions of the spatial coordinate system.

19. The electronic device according to claim 16, wherein the inertial sensor is positioned on a surface of the input device.

20. The electronic device according to claim 16, wherein the inertial sensor is positioned inside the input device.
